(19) United States
(12) Patent Application Publication
(10) Pub. No.: US 2011/0219648 A1
(43) Pub. Date: Sep. 15, 2011

(54) LED EDGE-LIT SIGNAGE UTILIZING DIGITAL PRINT TECHNOLOGY

(76) Inventors: Trevor James, Calgary (CA); Richard Brown, Calgary (CA)

(21) Appl. No.: 12/722,781

(22) Filed: Mar. 12, 2010

(51) Int. Cl. G09F 13/18

(52) U.S. Cl. 40/546

(57) ABSTRACT

An LED edge-lit sign comprises a transparent light panel, an image-carrying sheet in front of the light panel and a reflective back plate behind the light panel. The image to be displayed is printed onto the image-carrying sheet and a translucent layer of white ink is uniformly applied over the printed image. The result is uniform and effective back lighting of the image. A transparent window may be provided to view a changeable display therethrough.

### FIELD OF THE INVENTION

This invention relates to illuminated signage comprising an LED edge-lit light panel.

### BACKGROUND OF THE INVENTION

Illuminated image signage is used where there is insufficient illumination at night is for a sign to be seen, or where increased awareness of the sign is desired. Increasingly, image signage is being illuminated using LED edge-lighting. LEDs offer low voltage DC operation, low power consumption, long life without maintenance, and rugged construction that is immune to vibration and shock.

Edge lighting with LEDs provides the additional advantage of enabling extremely thin signs that are esthetically pleasing. LEDs are well suited to such applications because of their small size and directional propagation of light.

The preparation of LED edge-lit signage typically involves engraving or laser-etching an image to be illuminated onto a surface of a transparent edge-lit acrylic panel. In addition to being relatively labor-intensive, engraving of edge-lit transparent acrylic results in only the engraved image being illuminated while the remainder of the sign is not. This type of solution has been widely used in ‘EXIT’ signs, for example. In order to create signage that conveys more information than can reasonably be engraved, LED edge-lit signage may include back plates behind the engraved layer wherein the back plate has a background contrast or an un-illuminated background image that is created separately from the engraved image. Alternatively multiple engraved layers with different colors of LEDs in each layer are used, which increases the cost and bulk of the signage.

The advent of improved printing technology such as flatbed printers capable of printing on large acrylic sheets enables the consideration of innovative approaches to LED-illuminated signage that offer the promise of reducing the cost while improving the appearance of LED edge-lit signage.

It is therefore an object of this invention to providean improved LED edge-lit sign that reduces the labor and cost involved in the preparation of prior art engraved or laser-etched panels, of simplifying the production of signage with more visual information, and of providing enhanced illumination of all portions of the image that previously would have required several image engravings or layers.

These and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

This present invention enables the effective use of sheet printing technology in the production of edge-lit illuminated signage. The entire image to be displayed is printed (rather than being engraved or etched) on the back side of a thin transparent (preferably acrylic) image-carrying sheet and is then covered in a translucent layer of white ink. A separate edge-lit transparent light panel diffuses light to backlight the image-carrying sheet.

A reflector back plate is used behind the light panel to constrain the light to diffuse through the front surface of the light panel.

Frontward diffusion of the light from the light panel is provided by a matrix of printed, engraved, silkscreened or etched dots or hexagons on the front surface of the light panel. In the preferred embodiment, the light panel is edge-lit preferentially from the top edge and the density of the dot matrix graduates from a low density adjacent the lit edge to a high density distal from the lit edge to provide a uniform backlighting of the image.

Preferably, the printing is done using a flatbed ink-jet printer or laser printer. Since such printers can be provided with their image directly from web-based software, the printing technique allows a web-based solution in which a customer is can provide image on a template on a web-site which is then provided directly to the printer, and turned into an illuminated sign.

Additionally, a portion of the printed acrylic can be left clear to act as a window through which to display changeable information using a digital display mounted behind the window.

The foregoing was intended as a broad summary only and of only some of the aspects of the invention. It was not intended to define the limits or requirements of the invention. Other aspects of the invention will be appreciated by reference to the detailed description of the preferred embodiment, including the drawings.

### BRIEF DESCRIPTION OF THE DRAWINGS

The invention will be described by reference to the detailed description of the preferred embodiment and to the drawings thereof in which:

FIG. 1 is a perspective view of a top edge-lit LED light panel used in the preferred embodiment of the invention;

FIG. 2 is a perspective view of a portion of the light panel of FIG. 1 illustrating internal reflection from an edge of the panel;

FIG. 3 is a perspective view of a portion of the light panel showing a matrix of light-diffusing hexagon dots on the front surface of the panel;

FIG. 4 is an exploded view of an illuminated sign according to the preferred embodiment;

FIG. 5 is a rear perspective view of an image-carrying sheet according to the preferred embodiment; and,

FIG. 6 illustrates a completed sign with images according to the preferred embodiment, including the use of clear windows to present a variable digital display component of the image.

### DETAILED DESCRIPTION OF THE PREFERRED EMBODIMENT

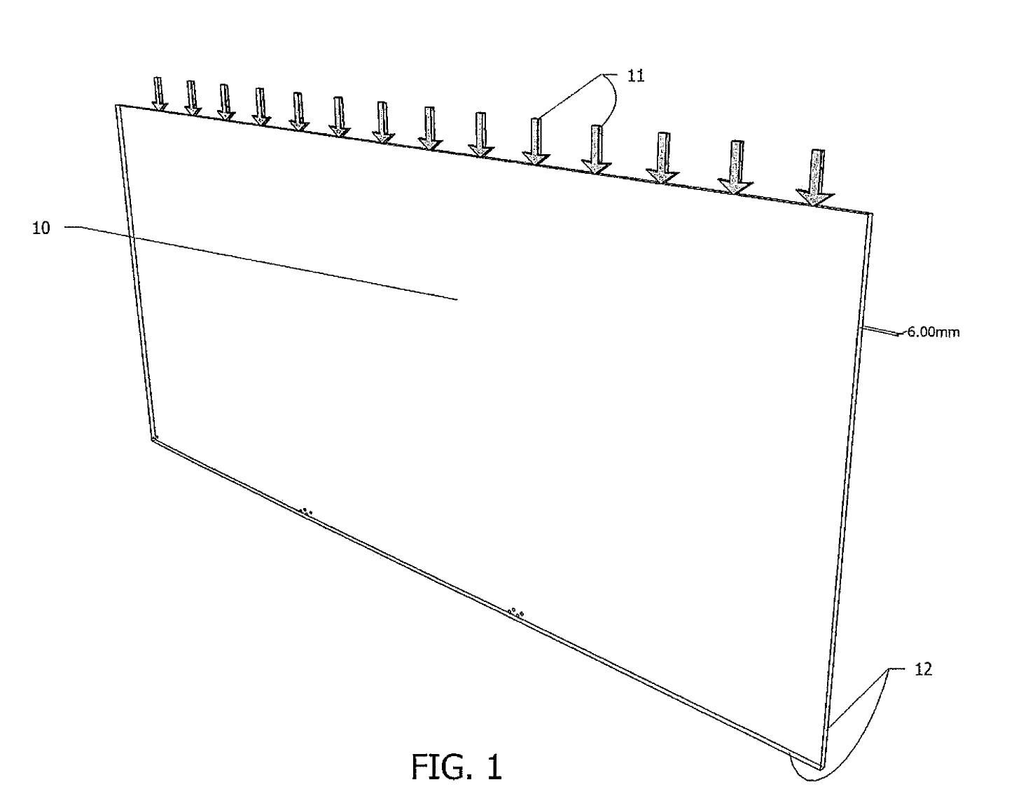

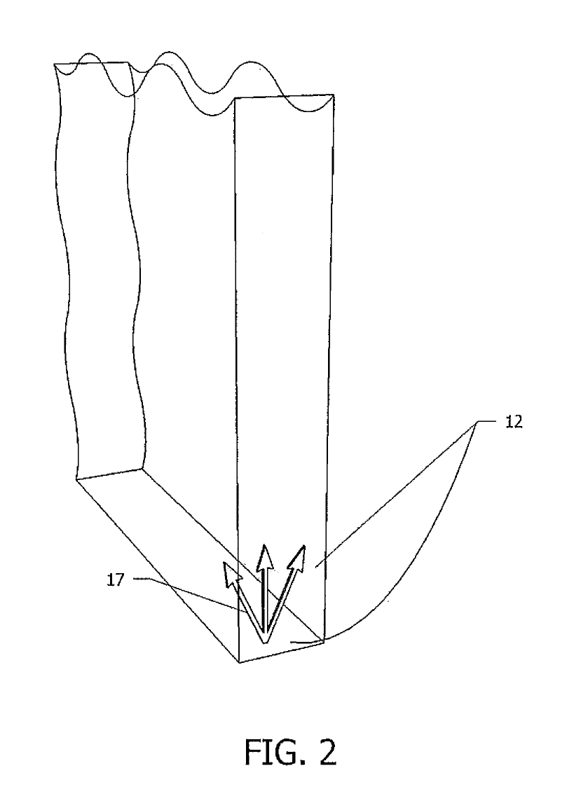

FIG. 1 illustrates a top edge-lit LED light panel 10 used in the preferred embodiment of the invention. Light panel 10 may consist of a single sheet of 6 mm transparent acrylic. As is known, LEDs are provided at or near one or more edges of the panel to propagate light within the body of the panel. The edges 12 of the sheet are typically provided with a reflective material (which may be white paint) to reflect the light internally (17) as illustrated in FIG. 2. In the preferred embodiment, the panel is lit (11) only from its top edge, but the invention is equally applicable to lighting from other edges or from a plurality of edges.

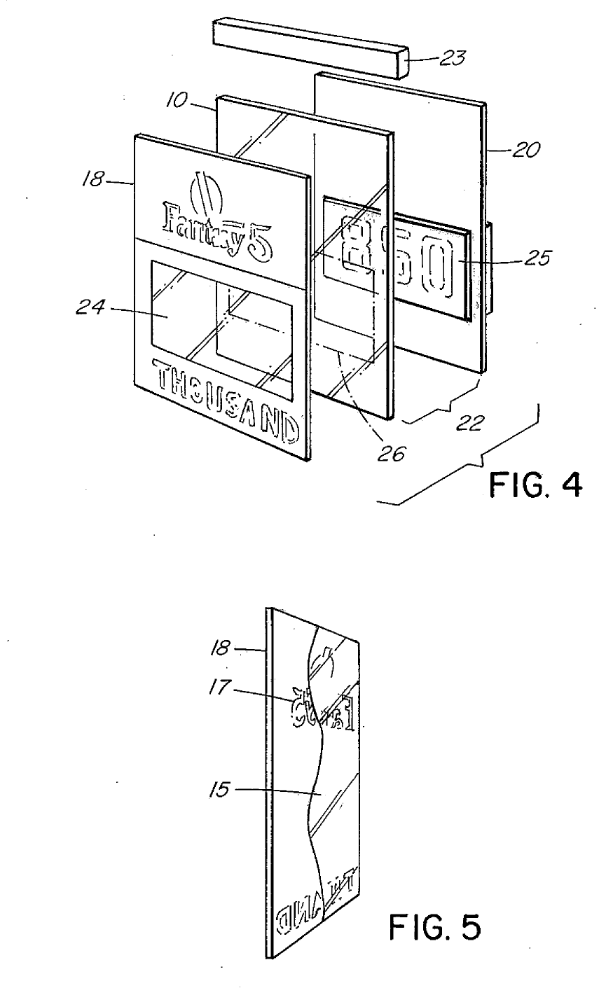

Referring to FIG. 4, the preferred embodiment includes an image-carrying sheet 18, the light panel 10 mounted co-planar with and to the print side of the image-carrying sheet 18 (opposite the viewing side of the image-carrying sheet 18) and a reflective back plate 20 mounted coplanar with and behind the light panel 10 (on the opposite side of the light panel from the image-carrying sheet). A gap 22 may be provided between the light panel 10 and the reflective back plate 20, as discussed below.

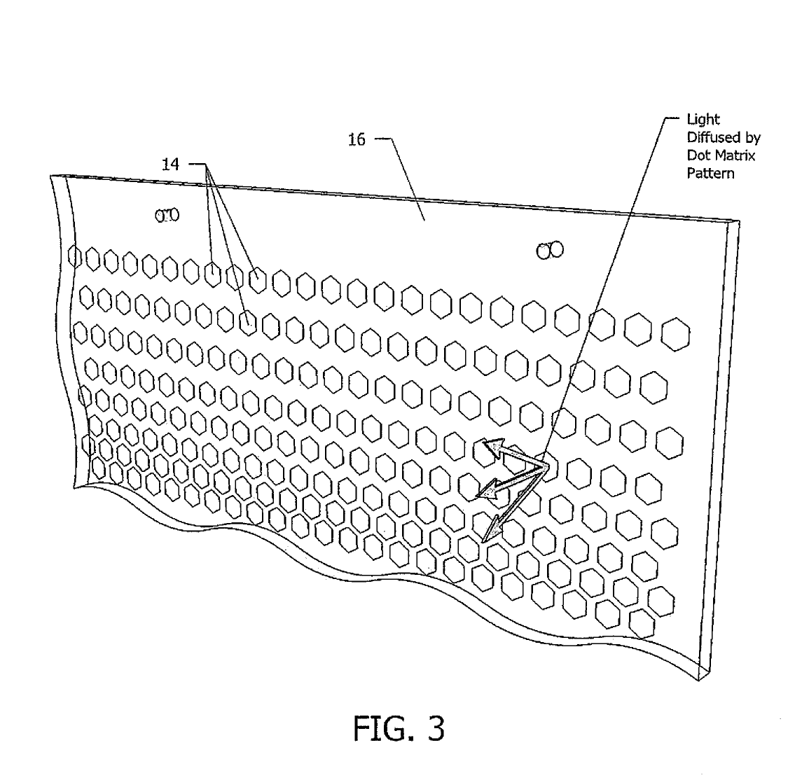

Referring now to FIG. 3, frontward diffusion of the light from the light panel may be provided by using a matrix of printed, engraved, silkscreened or etched elements such as dots 14 on the front surface (viewer side) of light panel 10 that faces the image-carrying sheet. The dots, which in the preferred embodiment are hexagonal, provide a diffusing rather than a reflective surface, allowing the light to pass through the front surface 16 of the panel.

Given that the preferred embodiment of the light panel is preferentially edge-lit from the top edge, in order to provide a uniform backlighting of the image the dot matrix is provided with a density gradient from a low density adjacent the lit edge to a high density distal from the lit edge. Other arrangements may be contemplated where more than one edge is lit, or where it is desired to provide non-uniform backlighting for the image.

Referring to FIG. 4, approximately half the light scattered within light panel 10 tends to exit the rear of the light panel. This light is reflected back to and through the light panel 10 by the reflective back plate 20. In the preferred embodiment the back plate is made of 2 mm thick Dibond (a trademark of Alcan Composites USA Inc.) or equivalent white painted aluminum sheet. A gap 22 of 2-3 mm is provided between light panel 10 and back plate 20. Gap 22 facilitates the positioning between the back plate and the light panel of a digital display if an appropriate window is provided in the light panel and in the image-carrying sheet, as discussed below.

Referring to FIG. 5, a reverse 17 of the image to be illuminated may be directly printed digitally on the back (print side) of a ‘graphic front plate’ (image-carrying sheet 18) made of 2 mm of an otherwise clear acrylic. Once the image has been printed, the surface of the image, again being the print side that faces the light panel 10, is then printed or silkscreened so as to uniformly cover the printed is image with a translucent layer 15 of white. In the preferred embodiment, the translucent layer is 4 microns thick white ink and is applied using an ink-jet flatbed printer. The layer 15 appears to be effective to enhance the visibility and uniform brightness of the colors of the image 17. A suitable ink is Anapurna White G1 Ink by Agfa comprising 60-80% acrylate, 5-10% phosphine oxide, diphenyl and 1-5% benzophenone but it is believed that other inks may also be suitable provided that they provide a white translucent covering for the back of the image-carrying sheet.

The image-carrying sheet 18, the light panel 10 the backplate 20 and the gap 22 are retained in the assembly by a suitable frame for example an extruded housing 23.

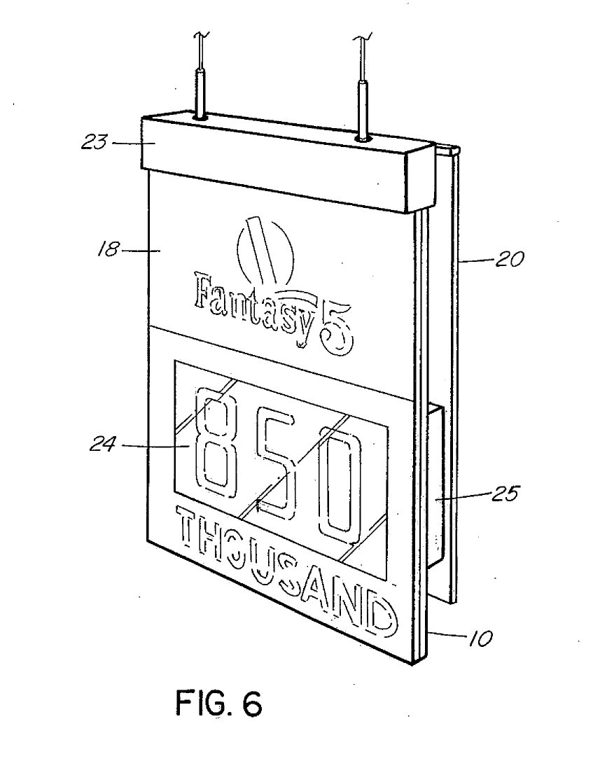

As seen in FIG. 4, light panel 10 and the image-carrying sheet 18 may be provided with overlapping transparent or clear windows (which may be cut-outs) 24, 26 allowing changeable digital information to be presented and viewed by means of a changeable digital display 25 secured behind the windows, resulting in a completed sign having the appearance shown in FIG. 6. This provides the opportunity for an illuminated image with both static and variable components.

Where a clear window is not required, an image-carrying sheet 18 that is translucent rather than transparent may be used. In such case, the image would be printed to the front of the image-carrying sheet 18 rather than a negative of the image being printed to the back of the sheet.

As the invention enables the use of printing for the image-carrying sheet, rather to than engraving or etching, a customer can transmit the desired image to the sign maker who can then print directly from the image file provided by the customer.

It will be appreciated by those skilled in the art that the preferred and alternative embodiments have been described in some detail but that certain modifications may be practiced without departing from the principles of the invention.

1. An edge-lit illuminated sign comprising:
an image-carrying sheet a viewing side and a print side, an image to be displayed or its negative being printed on said print side;
a translucent layer of white covering said printed image on said print side;
a transparent edge-lit light panel mounted co-planar with and on the print side of, said image-carrying sheet; and,
a reflective back plate mounted co-planar with said light panel and on the opposite side of said light panel from said image-carrying sheet.

2. The sign of claim 1 wherein said image-carrying sheet is made of a transparent acrylic.

3. The sign of claim 1 wherein said layer of white is formed of white ink.

4. The sign of claim 3 wherein said layer of white ink is printed or silkscreened onto said print side over said printed image.

5. The sign of claim 1 or 4 wherein said light panel further comprises a printed matrix of small elements on the surface of the light panel that faces said image-carrying sheet.

6. The sign of claim 1 or 4 where said light panel further comprises a printed matrix of dots on the surface of the light panel that faces said image-carrying sheet.

7. The sign of claim 1 or 4 where said light panel is preferentially edge-lit from a lit edge of said light panel and said light panel further comprises a printed matrix of dots on the surface of the light panel that faces said image-carrying sheet, said matrix graduating in density from a low density proximal to said lit edge to a high density distal from said lit edge.

8. The sign of claim 4 wherein each of said image-carrying sheet, said light panel and said reflective back plate comprises overlapping transparent or cut-out windows, and wherein said sign further comprises a changeable display viewable through said windows.
